(19) United States
(12) Patent Application Publication
(10) Pub. No.: US 2008/0256131 A1
(43) Pub. Date: Oct. 16, 2008

(54) Factory equipment, factory equipment control method, and factory equipment control apparatus

(75) Inventor: Fumiharu Shimohara, Kariya-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/080,935

(22) Filed: Apr. 7, 2008

(30) Foreign Application Priority Data
Apr. 13, 2007 (JP) 2007-106238

(51) Int. Cl. G06F 17/30

(52) U.S. Cl. 707/104.1; 707/E17.009

(57) ABSTRACT

A Factory Equipment provided with a control apparatus, equipment to be controlled, and safety measures provided for safety, wherein a memory of the control apparatus stores a work content-worker type relationship table and a work content-equipment operation relationship table, a work content judgment unit refers to the work content-worker type relationship table based on an input worker type from an worker type input unit and an input work content from a work content input unit to judge if a worker of the input worker type can perform the input work content, and, when it is judged that the input work content can be performed, an equipment operation judgment unit refers to a work content-equipment operation relationship table based on the work content and safety conditions input from a safety condition detection unit so as to judge if equipment can be operated.

### TECHNICAL FIELD

The present invention relates to a Factory Equipment, Factory Equipment control method, and Factory Equipment control apparatus, more particularly relates to a production Equipment provided with safety measures and a control method and control apparatus for such a Factory Equipment.

### BACKGROUND ART

Recent production Equipments have increasingly been geared up for shorter run production of more diverse types of products. The product lifecycles are also tending to become shorter. Further, collaborate activity is becoming globalized. Production Equipments are also being located all around the world and the optimal production there is being sought. Therefore, production Equipments have to change to meet with the changes in the products produced of course and also change to-meet with the changing environment such as the amounts of production, workers, and production sites.

Further, common global standards are being formulated for the safety of these production Equipments. Production Equipments which can ensure safety are being sought. However, in the past, each time a production Equipment was changed, a risk assessment had to be made, sources of danger pinpointed and safety measures devised, and a control flow chart prepared for controlling the operation of the production Equipment (see Japanese Patent Publication (A) No. 2003-263212).

In preparing the control flow chart for operating a production Equipment given such safety measures, the results of the risk assessment are used to prepare a Factory Equipment operation control flow chart expressed by a program such as a ladder diagram so that outputs (for example, the equipment held in the Factory Equipment) are obtained corresponding to the input conditions (for example work content, workers, and safety conditions). The prepared Factory Equipment operation control flow chart is usually enormous. Further, the prepared flow chart was dependent in large part on the individual preparing the flow chart.

Therefore, when changing the Factory Equipment unit operation control flow chart along with a change in the work content corresponding to the skill of the workers, a change of the automation level of the Factory Equipment, the level of skill of the region where the Factory Equipment is located, and changes in work content corresponding to local customs, analyzing the control flow chart was often time-consuming and changing the control flow chart was troublesome. In this way, construction of the control flow chart for a production Equipment given safety measures based on risk assessment required time and trouble, so it was not easy to make changes to a once constructed production Equipment to match with changes in its environment.

### SUMMARY OF THE INVENTION

The present invention, in consideration of the above problems, has as its object the provision of a Factory Equipment, Factory Equipment control method, and Factory Equipment control apparatus which enable easy, uniform construction of a control system and can be easily changed when the Factory Equipment has to be changed.

To achieve the object of the present invention, according to a first aspect of the invention, there is provided a Factory Equipment having at least one piece of equipment and at least one safety measure, comprising a worker type input unit inputting a type of worker, a work content input unit for inputting a work content, a safety condition detection unit detecting a state of the safety measure, a memory storing a work content-worker type relationship table defining whether the work content can be performed for each type of worker and a work content-equipment operation relationship table prepared for each work content and defining whether the equipment can be operated in accordance with the safety conditions, a work content judgment unit referring to the work content-worker type relationship table based on the input worker type from the worker type input unit and the input work content from the work content input unit so as to judge if the worker of the input worker type can perform the input work content, and an equipment operation judgment unit referring to the work content-equipment operation relationship table based on the work content and the safety conditions input from the safety condition detection unit when it is judged that the input work content can be performed so as to judge if the equipment can be operated.

Due to this, the conventional control flow chart is no longer necessary. The work content-worker type relationship table and work content-equipment operation relationship tables may be used to control the equipment. Further, when changing the control of the Factory Equipment, it is possible to change the contents of the work content-worker type relationship table and work content-equipment operation relationship tables.

The Factory Equipment may be further provided with a relationship information changing means for changing at least one of information of the work content-worker type relationship table showing if work is possible and information of the work content-equipment operation relationship tables showing if operation is possible. Due to this, the contents of the work content-worker type relationship table or work content-equipment operation relationship tables can be easily changed.

The work content-worker type relationship table may display types of workers and work contents as row and column headings and store information on whether the work is possible in the cells at the intersections of the rows and columns. Further, the work content-equipment operation relationship tables may display combinations of the safety conditions and the equipment as row and column headings and store information on whether the equipment can be operated in the cells at the intersections of the rows and columns.

If configuring the work content-worker type relationship table and the work content-equipment operation relationship tables as easily readable tables in this way, management becomes easy and the contents of the tables can be easily changed when necessary.

According to a second aspect of the invention, there is provided a control method for a Factory Equipment having at least one piece of equipment and at least one safety measure, comprising; inputting a type of worker, inputting a work content, detecting a state of the safety measure, referring to a work content-worker type relationship table showing the work content which can be performed for each type of worker based on the input worker type and the input work content so as to judge if a worker of the input worker type can perform the input work content, referring to a work content-equipment operation relationship table prepared for each work content and defining whether the equipment can be operated in accordance with predetermined safety conditions based on the work content and the detected safety conditions when it is judged that the input work content can be performed so as to judge if the equipment can be operated, and controlling the operation of the equipment based on the judgment of the equipment operation.

Due to this, there is no need to prepare a control flow chart like in the past. It is possible to control the operation of the equipment in accordance with the work content-worker type relationship table and work content-equipment operation relationship tables. Further, the control can be easily changed by rewriting the contents of the work content-worker type relationship table and the work content-equipment operation relationship tables.

The work content-worker type relationship table may display types of workers and work contents as headings of rows or columns and store information on whether work is possible in cells at the intersections of the rows and columns. Further, the work content-equipment operation relationship tables may display combinations of the safety conditions and the equipment as headings of rows or columns and store information on whether the equipment can be operated in cells at the intersections of the rows and columns.

If making the work content-worker type relationship table and the work content-equipment operation relationship tables easily understandable forms of tables, management becomes easy and the contents of the tables can be easily changed when necessary.

According to a third aspect of the invention, there is provided a Factory Equipment control apparatus controlling a Factory Equipment having at least one piece of equipment and at least one safety measure, comprising a memory storing a work content-worker type relationship table defining whether the work content can be performed for each the type of worker and a work content-equipment operation relationship table prepared for each work content and defining whether the equipment can be operated in accordance with the safety conditions, a work content judgment unit referring to the work content-worker type relationship table based on the input worker type and the input work content to judge if the worker of the input worker type can perform the input work content, and an equipment operation judgment unit referring to the work content-equipment operation relationship tables based on the work content and safety conditions showing the state of the safety measures when it is judged that the input work content can be performed so as to judge if the equipment can be operated.

Due to this, it is possible to control equipment by the work content-worker type relationship table and work content-equipment operation relationship tables without preparing a control flow chart. Further, even when changing Factory Equipment control, the change can be easily made by changing the contents of the work content-worker type relationship table and the work content-equipment operation relationship tables.

The work content-worker type relationship table may display types of workers and work contents as headings of rows or columns and store information on whether work is possible in cells of the intersections of the rows and columns. Further, the work content-equipment operation relationship tables may display combinations of the safety conditions and the equipment as headings of rows or columns and store information on whether the equipment can be operated in cells at the intersections of the rows and columns.

If making the work content-worker type relationship table and the work content-equipment operation relationship tables easily understandable forms of tables, management becomes easy and the contents of the tables can be easily changed when necessary.

### BRIEF DESCRIPTION OF THE DRAWINGS

These and other objects and features of the present invention will become clearer from the following description of the preferred embodiments given with reference to the attached drawings, wherein:

FIG. 1 is a view for explaining the present invention in brief;

FIG. 2 is a view showing a production Factory Equipment of a first embodiment of the present invention;

FIG. 3 is a view showing the results of risk assessment of a first embodiment of the present invention;

FIG. 4 is a view showing a work content-worker type relationship table of a first embodiment of the present invention;

FIG. 5 is a view showing a work content-equipment operation relationship table of a mode 1 of a first embodiment of the present invention;

FIG. 6 is a view showing a work content-equipment operation relationship table of a mode 2 of a first embodiment of the present invention;

FIG. 7 is a view showing a work content-equipment operation relationship table of a mode 3 of a first embodiment of the present invention;

FIG. 8 is a view showing a first half of a Factory Equipment operation element control diagram of a first embodiment of the present invention;

FIG. 9 is a view showing a second half of a Factory Equipment operation element control diagram of a first embodiment of the present invention;

FIG. 10 is a view showing a change in a work content-worker type relationship table of a first embodiment of the present invention; and

FIG. 11 is a view showing a work content-equipment operation relationship table of a mode 3 of a first embodiment of the present invention.

### BEST MODE FOR CARRYING OUT THE INVENTION

Below, the embodiments will be explained with reference to the drawings, but before that the feature of the embodiments will be summarized in brief.

As explained above, in the past, when the risk assessment ended, the practice had been to summarize the relationships between the input conditions summarized on the risk assessment sheet and the outputs, that is, the equipment, on a Factory Equipment operation control flow chart and prepare relay control circuits and ladder diagrams or programs for control of the operation of the outputs.

According to the embodiments, instead of the conventional Factory Equipment operation control flow chart, a work content-worker skill relationship table expressing the relationship between work content and worker skill and a work content-equipment operation relationship tables expressing the relationship between work content and the Factory Equipment units operated at the time of each work are prepared. The production Equipment according to the present invention stores the work content-worker skill relationship table and the work content-equipment operation relationship tables in the memory and controls operation of the equipment in accordance with the workers, work content, and safety conditions based on these two types of tables.

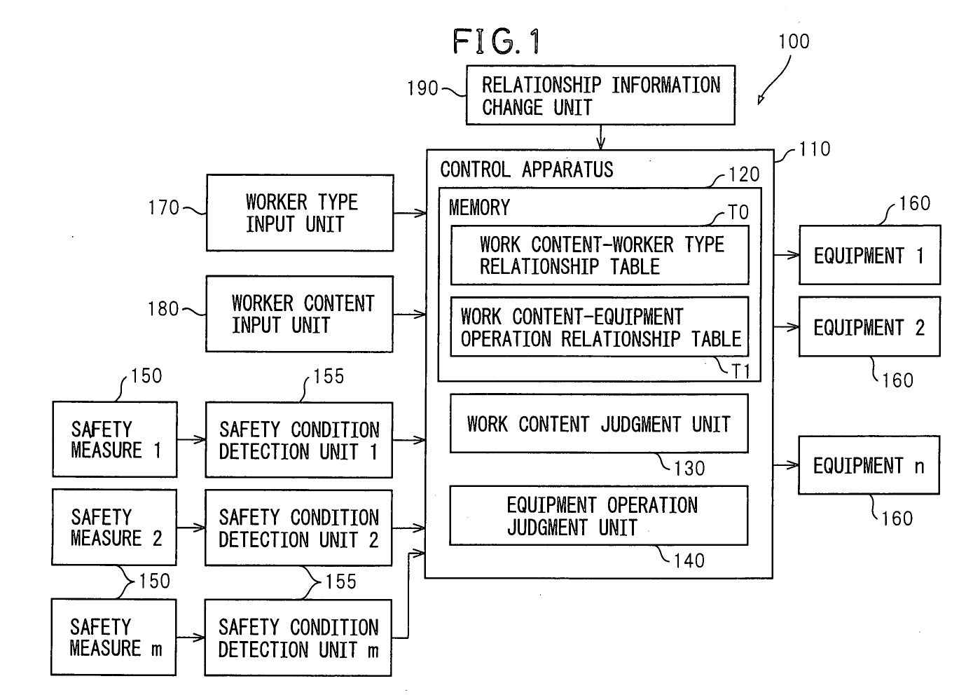

FIG. 1 is a block diagram showing the concept of a Factory Equipment according to the embodiments. The production Equipment 100 is provided with a control apparatus 110, any number of equipment 160, and any number of safety measures 150. The control apparatus 110 decides on the operation of the equipment 160 based on the inputs from the input unit 170 inputting the worker type as classified by the skill of the workers etc., the work content input unit 180 to which the work content is input, and the safety condition detection unit 155 detecting the state of the safety measures 150.

The control apparatus 110 is provided with a memory 120, a work content judgment unit 130, and an equipment operation judgment unit 140. The memory 120 stores a work content-worker type relationship table T0 defining whether work of the work content can be performed in accordance with a worker type and a work content-equipment operation relationship table T1 prepared for each work content and defining whether equipment can be operated in accordance with predetermined safety conditions.

The work content judgment unit 130 refers to the work content-worker type relationship tables T1 when there is input from the worker type input unit 151 and work content input unit 152 to judge if a worker of the input worker type can perform the input work content.

When the work content judgment unit 130 judges that the work content can be performed, the equipment operation judgment unit 140 further considers the safety conditions input from the safety condition detection unit 155 and refers to the work content-equipment operation relationship tables T1 to judge if the equipment can be operated. Further, it is possible to provide a relationship information change unit 190 to change the information designating the relationships in the work content-worker type relationship table T0 and work content-equipment operation relationship tables T1.

According to the embodiments, there is no longer a need for a control flow chart like in the past. It is possible to control equipment by a work content-worker type relationship table T0 and work content-equipment operation relationship tables T1. Further, even when a change in the work content, worker type, Factory Equipment automation level, installation site, etc. necessitates a change in the production Equipment, it is possible to easily and uniformly build the optimum Factory Equipment matching the safety conditions by just changing the work content-worker type relationship table T0 or work content-equipment operation relationship tables T1.

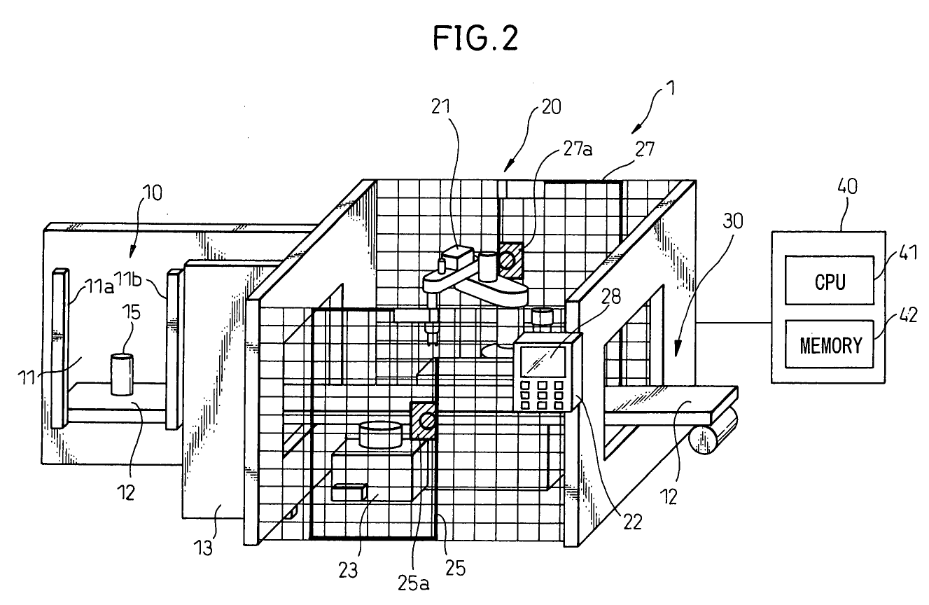

FIG. 2 is a view showing a workpiece processing Factory Equipment of an embodiment in brief. The processing Factory Equipment 1 is provided with a loading station 10 for loading a workpiece 15 as an object to be processed, a processing chamber 20, and an unloading station 30 and is controlled by a control apparatus 40. The workpiece 15 is placed on a conveyor 12 such as a belt conveyor at the loading station 10, conveyed into the processing chamber 20, processed in a state carried on the conveyor 12, then conveyed by the conveyor 12 to the unloading station 30.

The loading station 10 is provided with a light curtain 11. The light curtain 11 is comprised of a pair of a light projection unit 11a and a light reception unit 11b arranged facing each other and is designed so that light emitted from the light projection unit 11a strikes the light reception unit 11b.

While explained in detail later, the light curtain 11 corresponds to the safety measure 3. When the light emitted from the light projection unit 11a strikes the light reception unit 11b, it is detected that the safety measure 3 is in effect and the safety condition 3 showing the state of the safety measure 3 is set ON. When the light curtain is interrupted by a worker or object, that state is detected and the safety condition 3 is set to OFF.

For example, the conveyor 12 can be stopped when a worker places a workpiece 15 on the conveyor 12 and thereby interrupts the light of the light curtain 11. Note that the space through which the conveyor passes between the loading station 10 and the processing chamber 20 is provided with a partition wall 13 to prevent entry of a worker or other object.

The processing chamber 20 is provided with a robot 21 for processing the workpiece and processes the workpiece 15 conveyed by the conveyor 12. Further, it is provided with a crushing unit 23 for crushing the end material. If there is any unnecessary end material at the time of processing, the robot 21 detects the end material and loads it into the crushing unit 23. The end material loaded into the crushing unit 23 is then crushed to dispose of it.

The processing chamber 20 is also provided with an input device 22 having a display unit 28. A worker uses a tenkey pad etc. to input work content to be executed. Further, he inputs an identification number for identifying himself, for example, an employee number, and a password etc. to the input device 22 so as to input the type of worker. Due to this, it is possible to safely operate various types of equipment so that the work content and the workers performing the work match. The display unit 28 may be used to confirm the content of the input. Further, it is also possible to display any cautions on work etc.

The processing chamber 20 is provided with a general work door 25 and a maintenance and inspection door 27. The general work door 25 is for workers in charge of ordinary processing work and is used for cleaning up waste etc. around the crushing unit 23. The maintenance and inspection door 27 is used when a skilled maintenance worker enters for robot maintenance and inspection work or for work teaching operations to be performed by the robot.

While explained in detail later, the general work door 25 corresponds to the safety measure 1. The general work door 25 is provided with a sensor for detecting opening/closing of the door or a sensor 25a for detecting locking of the door, whereby the open/closed state of the door can be detected. When the general work door 25 is closed, the safety measure 1 is in effect, and the safety condition 1 showing that the safety measure is in effect is set to ON. As opposed to this, when the general work door 25 is open, the safety condition 1 is OFF.

Further, the maintenance and inspection door 27 corresponds to the safety measure 2. The maintenance and inspection door 27 is also provided with a sensor 27a for detecting opening/closing of the door whereby the open/closed state of the door can be detected. When the maintenance and inspection door 27 is closed, the safety measure 2 is in effect, and the safety condition 2 showing that the safety measure is in effect is set to ON. As opposed to this, when the maintenance and inspection door 27 is open, the safety condition 2 is OFF.

The processing work of the workpiece 15 is performed under the control of the control apparatus 40. The control apparatus 40 can be configured from a known programmable controller. The control apparatus 40 is provided with a microcomputer (CPU) 41 and a memory 42. As explained in detail later, the memory stores the work content-worker type relationship table and work content-equipment operation relationship table. The CPU 41 judges the work content which a worker can perform and determines the operation of the equipment defined by the safety conditions for the work content.

The processed workpiece 15 is conveyed out by the conveyor 12 and unloaded at the unloading station 30. In another embodiment, the conveyor can be used to convey the workpiece 15 to the next Factory Equipment.

In the present embodiment, the work at the production Factory Equipment 1 is classified into three modes: production work where ordinary processing work is performed, abnormality restoration work of work for restoration when an abnormality occurs, and maintenance and inspection work including teaching robot operations. Greater skill is required for the work in the order of the general production (mode 1), abnormality restoration work (mode 2), and maintenance and inspection work (mode 3). Therefore, workers are also classified into three types in accordance with their degrees of skill.

A worker 1 is a maintenance worker with abundant knowledge and experience and can handle all of the modes 1 to 3. A worker 2 is a skilled worker, though not to the extent of the maintenance worker, and can handle the modes 1 and 2, but cannot handle the mode 3. A worker 3 is an unskilled worker, including new employees, and can handle only the mode 1 and cannot handle the modes 2 and 3.

Here, the classification of the work into the modes 1 to 3 is just an example. In general, work at a production Equipment is said to include the following work.
(1) Production work: General production activities,
(2) Production preparation work: Startup and shutdown of production Equipment
(3) Cleaning work: Cleaning of Factory Equipment
(4) Quality control work: Periodic check of quality of Factory Equipment using master workpieces, jigs, etc.
(5) Restoration of abnormalities: Work of restoring abnormalities in Factory Equipment (breakdowns, production of defective products, etc.)
(6) Adjustment work: Test operation, adjustment of operation speed and operation position, etc.
(7) Setup work: Replacement of tooling and jigs
(8) Inspection work: Work of checking status of Factory Equipment etc.
(9) Maintenance work: Replacement of consumables and broken parts

The production work of mode 1 of the present embodiment corresponds to the above (1), (3), and (4). Further, the abnormality restoration work of mode 2 corresponds to the above (5), while the maintenance and inspection work of mode 3 corresponds to the above (2), (6), and (9). However, the present invention is not limited to this. The modes of work are also not limited to three types. It is possible to classify work into the suitable number of work modes. There may even be just a single work mode.

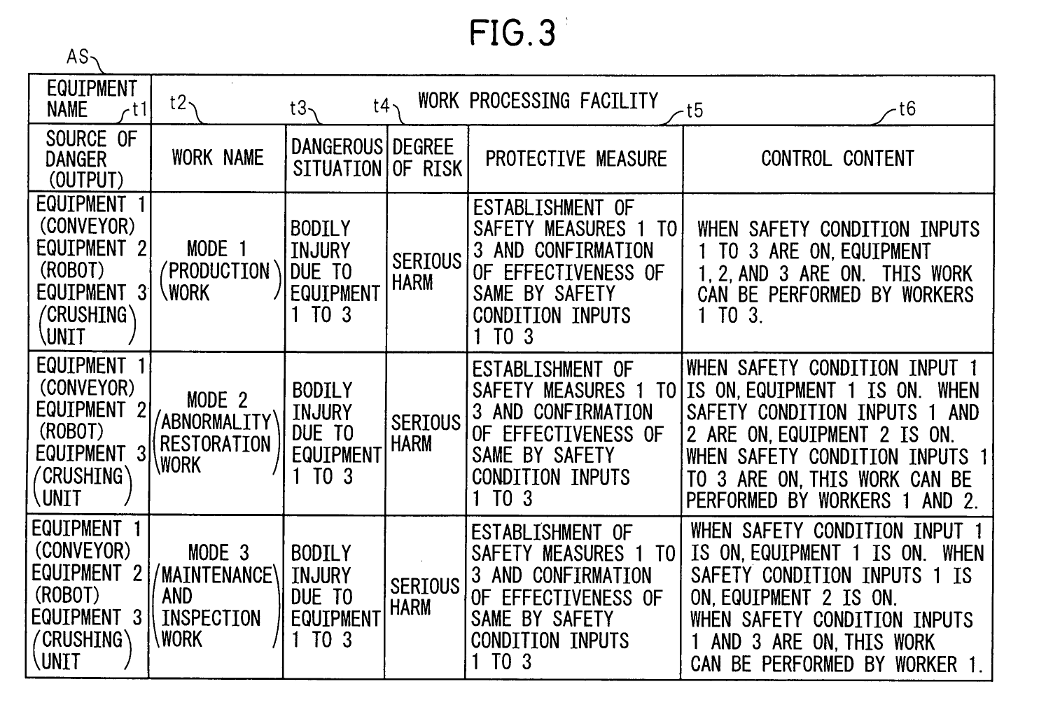

In the processing Factory Equipment of FIG. 2, when the work modes include the three types of work modes 1 to 3 and the worker types also include the three types of workers 1 to 3, the result of the risk assessment is for example summarized on a risk assessment sheet such as shown in FIG. 3.

The risk assessment sheet AS of FIG. 3 covers the source of danger t1, work name t2, dangerous situation t3, degree of risk t4, protective measure t5, and control content t6. The risk assessment sheet AS evaluates the risk of a specific source of danger for each mode (dangerous situation and degree of risk), sets measures for avoiding the risk (protective measures), and finally determines the control content for the source of danger based on the protective measure and worker.

In the workpiece processing Factory Equipment of FIG. 2, the sources of danger are the conveyor 12, robot 21, and crushing unit 23. In the risk assessment sheet T1, the conveyor 12, robot 21, and crushing unit 23 are designated as the equipment 1 to 3 or outputs 1 to 3. The equipment 1 to 3 are referred to as outputs 1 to 3 because the equipment 1 to 3 are what the control signals are output to.

In each work of the modes 1 to 3, as a dangerous situation, bodily injury where operation of the sources of danger, that is, the equipment 1 to 3 (conveyor 12, robot 21, and crushing unit 23), results in contact with the worker, for example, impact, entanglement, crushing, etc. may be envisioned. If such an accident occurs, the worker will be injured, so the degree of risk is positioned as “serious harm” in each case.

As safety measures for preventing dangerous situations, the safety measures 1 to 3 are provided. The safety measure 1 is the general work door 25. The safety measure 2 is the maintenance and inspection door 27. The safety measure 3 is the light curtain 11. When the general work door 25 is closed, the safety measure 1 is in effect. When the maintenance and inspection door 27 is closed, the safety measure 2 is in effect. When the light curtain 11 is interrupted, the safety measure 3 is in effect.

Whether the safety measures 1 to 3 are in effect is judged by the input of the corresponding safety conditions 1 to 3. That is, if the safety conditions 1 to 3 are ON, it indicates that the safety measures 1 to 3 are in effect.

Finally, the operations of the equipment 1 to 3 are set and the control content determined in accordance with the input of the safety conditions 1 to 3. The risk assessment is determined considering the evaluation of the degree of danger, safety measures, work content, workers, etc., so is not something determined unambiguously. In the risk assessment sheet AS, the highest degree of danger is deemed to be from the crushing unit 23 (equipment 3), followed by the robot 21 (equipment 2), while the lowest degree of danger is deemed to be from the conveyor 21 (equipment 1). This is an example of determination considering the modes 1 to 3 showing the work content and the workers 1 to 3.

The control content will be explained in detail later, but will be summarized in brief here first. In the present embodiment, the mode 1 can be performed by all workers including unskilled workers, the mode 2 can be performed by skilled workers and maintenance workers, and the mode 3 can be performed only by maintenance workers. Therefore, the safety measures are toughest for the mode 1 and laxer, considering the work content and work efficiency, in the order of the modes 2 and 3.

In the mode 1, since all workers including unskilled workers can perform the work, the equipment 1 to 3 can be operated so long as all of the safety condition inputs 1 to 3 are ON, in other words, all of the safety measures are in effect.

In the mode 2, since the workers 1 and 2(skilled workers and maintenance workers) can perform the work, the degree of danger can be higher than the mode 1 for the necessary work. Here, the equipment 1 can be operated if the safety input condition 1 is ON, that is, the safety measure 1 is in effect. The equipment 2 can be operated even without the safety measure 3 if the safety input conditions 1 and 2 are ON, that is, the safety measures 1 and 2 are performed. The equipment 3 can be operated, in the same way as the mode 1, when all of the safety condition inputs 1 to 3 are ON.

In the mode 3, the work can only be performed by a maintenance worker, so if necessary for the work, the degree of danger can be raised from the mode 2. Here, the equipment 1 can be operated if the safety input condition 1 is ON, that is, the safety measure 1 is performed while the equipment 2 can be operated is the safety input condition 1 is ON, that is, the safety measure 1 is performed. The equipment 3 can be operated not only when all of the safety condition inputs 1 to 3 are ON, but also when the safety condition input 1 is ON, the safety condition input 2 is OFF, and the safety condition input 3 is ON.

The risk assessment sheet AS is prepared in this way whereupon the risk assessment is ended.

According to the present invention, when the risk assessment ends, not the conventional Factory Equipment operation control flow chart, but a work content-worker type relationship table and work content-equipment operation relationship tables are prepared.

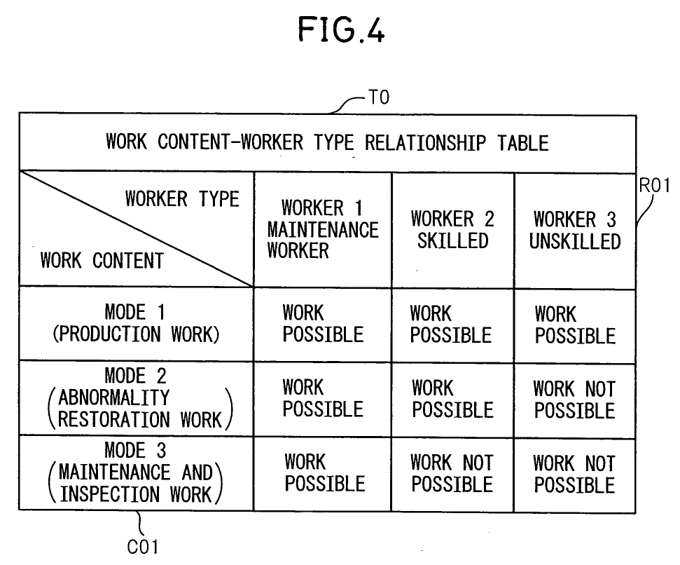

FIG. 4 is a view of a work content-worker type relationship table used in the present embodiment. The work content-worker type relationship table shows the correspondence between the work content and workers and is prepared according to whether workers with different knowledge, experience, rights, etc. can perform the work defined in the work content.

In the table of FIG. 4, the column C01 is given the heading “work content”, while the row R01 is given the heading “worker type”. The work content includes the mode 1 (production work), mode 2 (abnormality restoration work), and mode 3 (maintenance and inspection work). The workers are classified into a worker 1 (maintenance worker), worker 2 (skilled worker), and worker 3 (unskilled worker). All of the cells formed by intersections of the work content rows and worker type columns indicate whether the work is possible. For example, a maintenance worker can perform all of the work of the modes 1 to 3. A skilled worker can perform the work of the modes 1 and 2 and cannot perform the work of the mode 3. An unskilled worker can only perform the work of the mode 1.

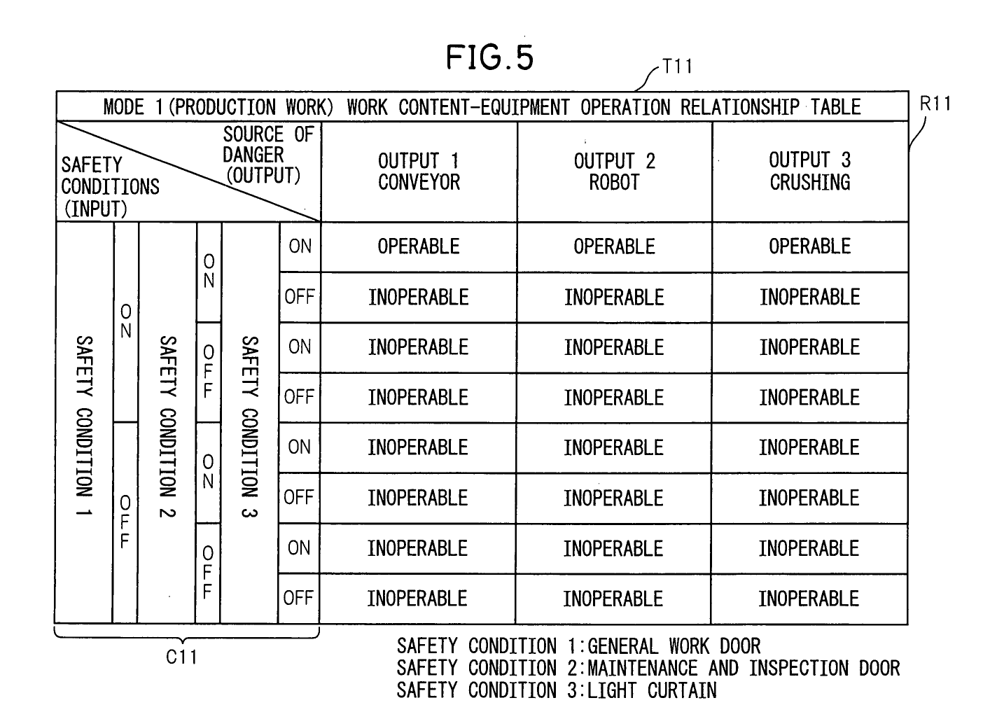

FIG. 5 to FIG. 7 are views showing the work content-equipment operation relationship tables used in the present embodiment. A work content-equipment operation relationship table is prepared for each work content, that is, for each mode, based on the control content of the risk assessment of FIG. 3.

FIG. 5 shows a work content-equipment operation relationship table of the mode 1 (production work). The row headings R11 and the column headings C11 of the work content-equipment operation relationship table are the same as in FIGS. 4 to 6.

The row headings R11 of the work content-equipment operation relationship table show the sources of danger. As explained above, the outputs 1 to 3 correspond to the sources of danger as posed by the equipment 1 to 3. The equipment 1 is a conveyor 12, the equipment 2 is a robot 21, and the equipment 3 is a crushing unit 23.

Further, the column headings C11 of the work content-equipment operation relationship table are combinations of all of the ON/OFF states of the safety conditions 1 to 3 corresponding to the effect/non effect of the safety measures 1 to 3. To enable the combinations of the safety conditions to be easily understood, at the ON/OFF states of the safety condition 1, the ON/OFF states of the safety condition 2 are arranged, while at the ON/OFF states of the safety condition 2, the ON/OFF states of the safety condition 3 are arranged. There are eight column headings for the (safety condition 1, safety condition 2, and safety condition 3) from (ON, ON, ON) to (OFF, OFF, OFF).

Here, the safety measure 1 is the maintenance and inspection door 27, the safety measure 2 is the general work door 25, and the safety measure 3 is the light curtain 11.

If the safety condition 1 is ON, this indicates that the safety measure 1 is in effect, that is, the maintenance and inspection door 27 is closed. If the safety condition 1 is OFF, this indicates that the safety measure 1 is not in effect, that is, the maintenance and inspection door 27 is open.

Further, if the safety condition 2 is ON, this indicates that the safety measure 2 is in effect, that is, the general work door 25 is closed. If the safety condition 2 is OFF, this indicates that the safety measures 2 is not in effect, that is, the general work door 25 is open.

If the safety condition 3 is ON, this indicates that the safety measure 3 is in effect, that is, the light curtain 27 is not being interrupted or is “closed”. If the safety condition 3 is OFF, this indicates that the safety measure 3 is not in effect, that is, light curtain 27 is being interrupted by a person or object or is “open”.

The meanings of the row headings and column headings of the above work content-equipment operation relationship table and the “operable” and “inoperable” in the cells of the table are the same for FIGS. 5 to 7.

As shown in FIG. 5, in the work content-equipment operation relationship table T11 of the mode 1 (production work), only when the safety conditions 1 to 3 are ON can the outputs 1 to 3, that is, the conveyor 12, robot 21, and crushing unit 23, operate. That is, in ordinary workpiece processing work of the mode 1, the workpiece processing work cannot be started until the maintenance and inspection door 27 is closed (safety condition input 1 is ON), the general work door 25 is closed (safety condition input 2 is ON), and the light curtain 11 is not interrupted by a person or object, that is, the light curtain 11 can be emitted (safety condition input 3 is ON).

If the general work door 25 and the maintenance and inspection door 27 are open, a worker might enter the processing chamber 20. Further, if the light curtain 11 is interrupted, there is a good change that a worker is working at the loading station 10. It is dangerous if starting work when any of the safety conditions 1 to 3 is not met in this way.

Therefore, in the mode 1, if any of the safety input conditions 1 to 3 is OFF, the conveyor 12, robot 21, and crushing unit 23 cannot be operated. That is, only when all of the safety input conditions 1 to 3 are ON can the equipment 1 to 3 be operated. This setting is based on the thinking that, considering the fact that even workers with low degrees of work skills will be working, it is safest to stop all operations when there is a possibility of approaching a source of danger.

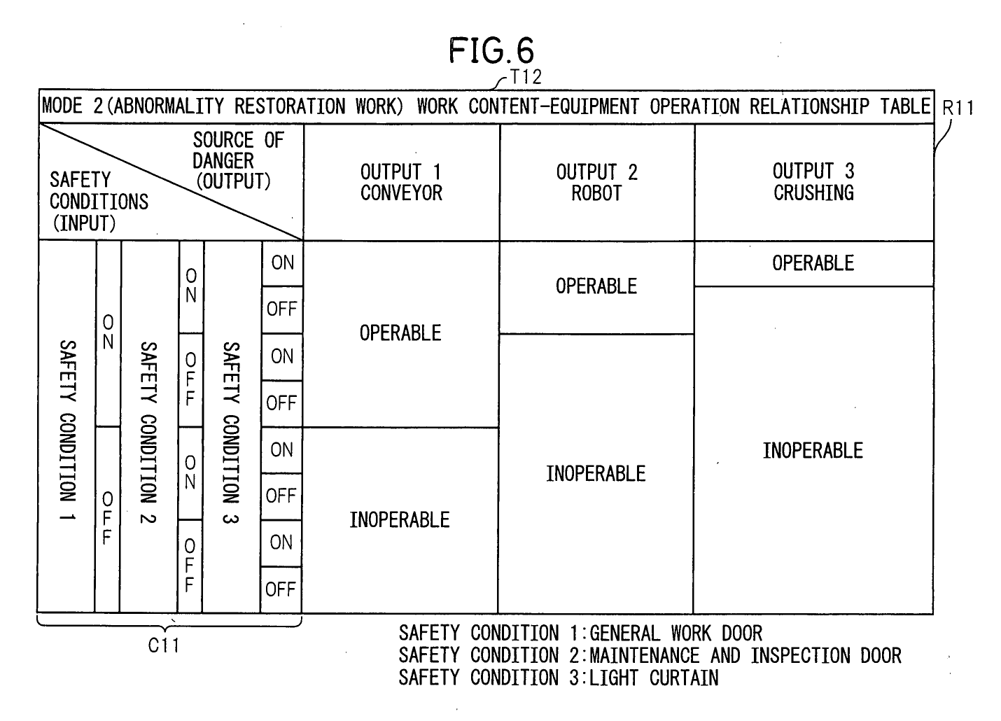

FIG. 6 shows a work content-equipment operation relationship table T12 of the mode 2 (abnormality restoration work). In the mode 2, only a skilled worker or maintenance worker can perform the work, so the degree of danger can be made higher than the mode 1 for the necessary work.

In the abnormality restoration work of the mode 2, when the general work door 25 is closed (safety condition 1 is ON), the conveyor 12 (output 1) can be operated regardless of the states of the safety conditions 2 and 3. However, when the general work door 25 is open (safety condition input 1 is OFF), the conveyor 12 (output 1) cannot be operated.

Therefore, if the general work door 25 is closed (safety condition input 1 is ON), the conveyor 12 can be operated even if the maintenance and inspection door 27 is opened. That is, a skilled worker or maintenance worker can enter the processing chamber 20 from the maintenance and inspection door 27 and perform abnormality restoration work even if the conveyor 12 is operating.

The robot 21 (output 2) can operate if the general work door 25 is closed (safety condition input 1 is ON) and the maintenance and inspection door 27 is closed (safety condition input 2 is ON). In the case of restoring the Factory Equipment from an emergency stop, as often performed as abnormality restoration work, there is the work of returning the robot to its initial position. This work can be set to be prohibited unless both doors 25 and 27 are closed so as to ensure safety. The work of returning the robot to its initial position can be performed regardless of the ON or OFF state of the light curtain 11 (safety condition 3), so is made to be performed even if the safety condition 3 is OFF.

The crushing unit 23, in the same way as the mode 1, is prevented from operating if the safety conditions 1 to 3 are not ON.

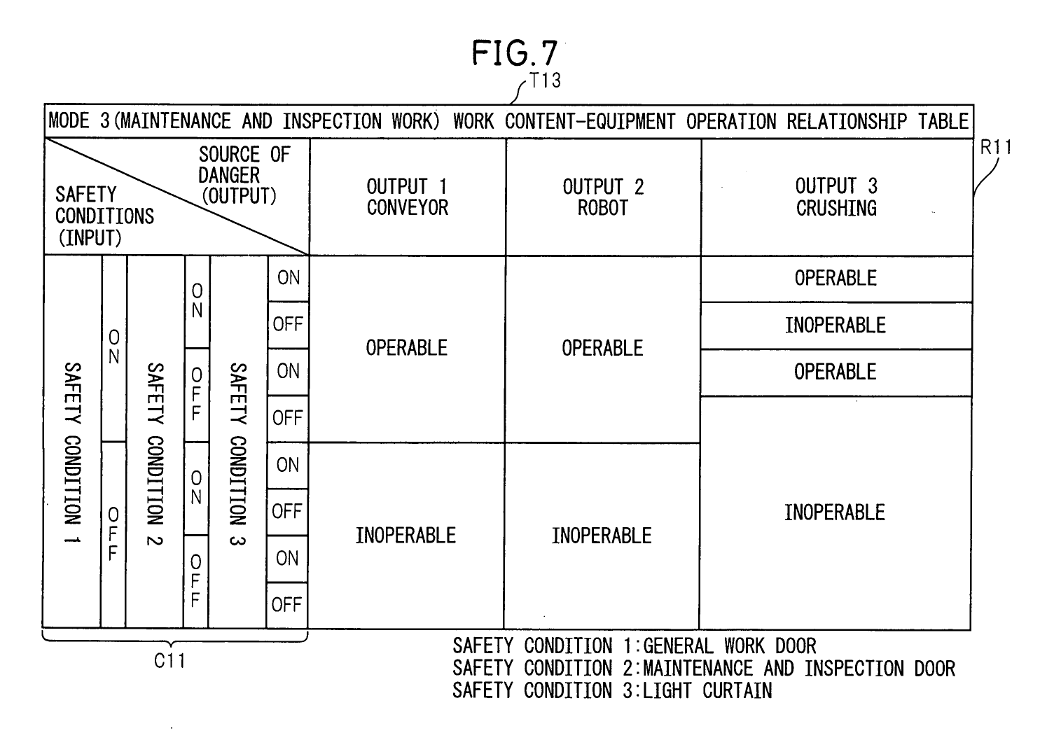

FIG. 7 shows a work content-equipment operation relationship table T13 of the mode 3 (maintenance and inspection work). The mode 3 (maintenance and inspection work) is handled by a maintenance worker having broad experience and sophisticated technical skill, so even if more dangerous than the mode 2, priority may be given to work efficiency.

In the maintenance and inspection work of the mode 3, first, the conveyor 12 (output 1), like in the mode 2, can be operated when the general work door 25 is closed (safety condition input 1 is ON) and cannot be operated when the general work door 25 is open (safety condition input 1 is OFF).

At the time of maintenance and inspection, the maintenance worker has to enter the processing chamber from the maintenance and inspection door 27 and operate the robot 21 using a teaching pendant etc. to inspect the robot, so the robot 21 (equipment 2) may be made operable even when the maintenance and inspection door 27 is open (safety condition 2 is OFF). However, if the general work door 25 is open (safety condition 1 is OFF), a person or object might enter from the general work door 25 and touch the robot, so when the general work door 25 is open (safety condition 1 is OFF), the robot 21 is prevented from operating.

For the crushing unit 23, operation is possible not only when all of the safety conditions 1 to 3 are ON common to the modes 1 and 2, but also when the safety conditions 1 and 3 are ON and the safety condition 2 is OFF. The safety condition 2 being “OFF” is the case where the maintenance and inspection door 27 is open and a maintenance worker can open the maintenance and inspection door 27 to inspect the crushing unit. Note that depending on the case, when the safety conditions 2 and 3 are ON and the safety condition 1 is OFF, it is also possible to make the crushing unit 23 operable. In this case, when only the general work door 25 is open, the general work door 25 can be used by a maintenance worker to enter the processing chamber and conduct an inspection.

In the production Factory Equipment 1 of the present embodiment, the work content-worker type relationship table T0 and the work content-equipment operation relationship tables T11 to T13 are stored in the memory 42 of the control apparatus 40 and used by the CPU 41 of the control unit for control of the production Equipment.

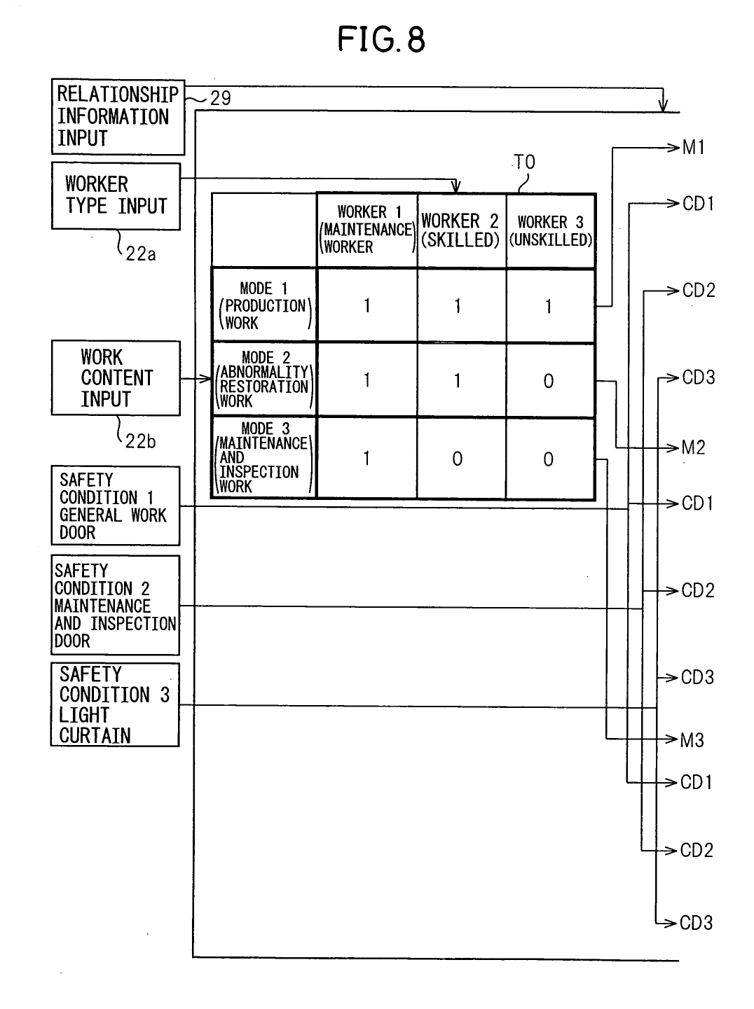

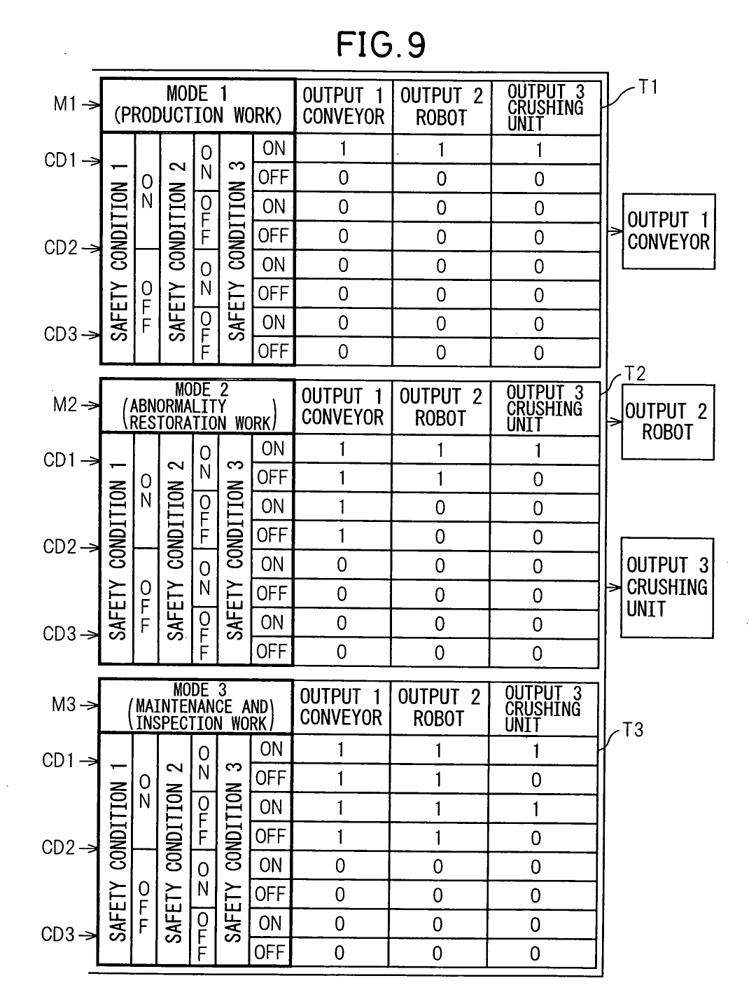

Next, based on the Factory Equipment operation element control diagram shown in FIGS. 8 and 9, how equipment is controlled using the work content-worker type relationship table and work content-equipment operation relationship tables will be explained. Note that the Factory Equipment operation element control diagram is actually drawn on a single sheet, but in this Description is split into FIGS. 8 and 9.

The Factory Equipment operation element control diagram is a view of a combination of the work content-worker type relationship table T0 and the work content-equipment operation relationship tables T11 to T13 combined as shown in FIGS. 8 and 9. In the work content-worker type relationship table T0 and the work content-equipment operation relationship tables T1 to T3 combined in the Factory Equipment operation element control diagram, “work possible” and “operable” are expressed by “1”, while “work not possible” and “inoperable” are expressed by “0”. In FIGS. 8 and 9, the signals showing the work modes 1 to 3 are respectively expressed as Ml to M3, while the signals showing the safety conditions 1 to 3 are respectively expressed as CD1 to CD4.

What are shown as input in the Factory Equipment operation element control diagram are the worker type input 22a and work content input 22b input from the input device 22 (FIG. 2), the safety conditions 1 to 3, and the relationship information input 29. The relationship information input 29 is the input of information for changing the values of the cells of the work content-worker type relationship table T0 and the work content-equipment operation relationship tables T11 to T13. Due to this, when changing a Factory Equipment, it is possible to easily rewrite the values “0” and “1” of the cells of the work content-worker type relationship table T0 and the work content-equipment operation relationship tables T1. Further, the outputs are the outputs 1 to 3 of the equipment under controlled.

When the worker type and the work content (work mode) are input, first the work content-worker type relationship table T0 is referred to and it is judged whether the worker of the input worker type can perform the work of the input work mode. Specifically, the logical AND of the input of the worker type, the input of the work mode, and the value of the corresponding cell of the work content-worker type relationship table T0 is output. If the output is “0”, the worker of the input worker type cannot perform the input work mode, so the processing is ended.

If the logical AND is “1”, that is, the worker can execute the work mode, one of the work content-equipment operation relationship tables T11 to T13 corresponding to the input work mode is referred to. In the work content-equipment operation relationship tables T11 to T13, the outputs are defined by the respective safety conditions, so operations of the outputs 1 to 3 are controlled in accordance with the detected safety conditions.

The work of referring to the work content-worker type relationship table to judge the relationship between the worker type and worker is performed in the present embodiment by the CPU of the control apparatus as the “work content judgment unit” defined in the claims. Further, the work of referring to the work content-equipment operation relationship tables to determine the operation of the equipment is performed similarly by the CPU of the control apparatus as the “work content judgment unit” defined in the claims.

For example, if an unskilled worker 3 inputs his own worker type and inputs the mode 1 (production work), the work content-worker type relationship table T0 is referred to, whereby it is learned that the worker 3 can perform the work of the mode 1.

Next, the work content-equipment operation relationship table T1 in the mode 1 (FIG. 8) is referred to and whether the outputs 1 to 3 can be operated is judged in accordance with the combinations of the safety conditions. In this case, only when all of the safety conditions 1 to 3 are ON, that is, are in effect, do the outputs 1 to 3 become “1”, that is, operable. Specifically, as explained above, only when the maintenance and inspection door 27 is closed (safety condition input 1 is ON), the general work door 25 is closed (safety condition input 2 is ON), and the light curtain 11 is not interrupted by a person or object (safety condition input 3 is ON), can any of the conveyor (output 1), robot (output 2), and crushing unit (output 3) operate.

Note that when an unskilled worker 3 inputs the work content as the mode 2, it is judged in accordance with the work content-worker type relationship table T0 that the combination of the worker 3 and the mode 2 is “0”, that is, the work is not possible, so the processing is ended without referring to the work content-equipment operation relationship tables T1 to T3.

Further, for example, if a skilled worker 2 inputs his own worker type and inputs the work content as the mode 2 (abnormality restoration work), the work content-worker type relationship table T0 is referred to and it is judged that the worker 2 can perform the work of the mode 2. Next, the work content-equipment operation relationship table T2 (FIG. 8) in the mode 2 is referred to and whether the operations of the outputs 1 to 3 are possible are determined in accordance with the combinations of the safety conditions. For example, when the safety condition 1 (general work door) is ON (closed), the safety condition 2 (maintenance and inspection door) is ON (open), and the safety condition 3 (light curtain) is OFF (light interrupted), the output 1 (conveyor) is controlled to be operable, the output 2 (robot) is controlled to be inoperable, and the output 3 (crushing unit) is controlled to be inoperable.

In the present embodiment, the output is determined in accordance with the combination of the states of all of the safety conditions for each work content determined by the input worker type and input work content. Further, when work cannot be performed by the worker type, the work is judged impossible in accordance with the work content-worker type relationship table T0, so the processing can be ended without referring to the work content-equipment operation relationship tables T1 to T3.

In general, when various conditions change, a production Equipment has to be changed accordingly. A Factory Equipment is changed to meet with changes in the product, changes in the worker type, changes in the automation level of the Factory Equipment, addition of safety measures, etc. Further, even when installing a production Equipment in another region, for example, overseas, the production Equipment often has to be changed. When installing a Factory Equipment in another region, it is necessary to change the production Equipment, including the work content and safety measures, to meet with the natural environment or the skill level of the workers of the region or the laws, customs, etc.

When changing a Factory Equipment, according to the present invention, it is possible to easily and uniformly change the production Equipment by just changing the values of the cells of the work content-worker type relationship table T0 and the work content-equipment operation relationship tables T11 to T13. Therefore, changes to the Factory Equipment or control sequence accompanying changes to various conditions and changes in the environment can be performed easily and uniformly without relying on the design skills of the designers.

The values of the cells of the work content-worker type relationship table T0 and the work content-equipment operation relationship tables T11 to T13 can be changed by utilizing an external personal computer in the same way as when changing the program of the control apparatus. Further, it is also possible to provide a relationship information change unit for changing the values of the tables in the Factory Equipment. Further, the relationship information change unit can also serve as the input unit 22.

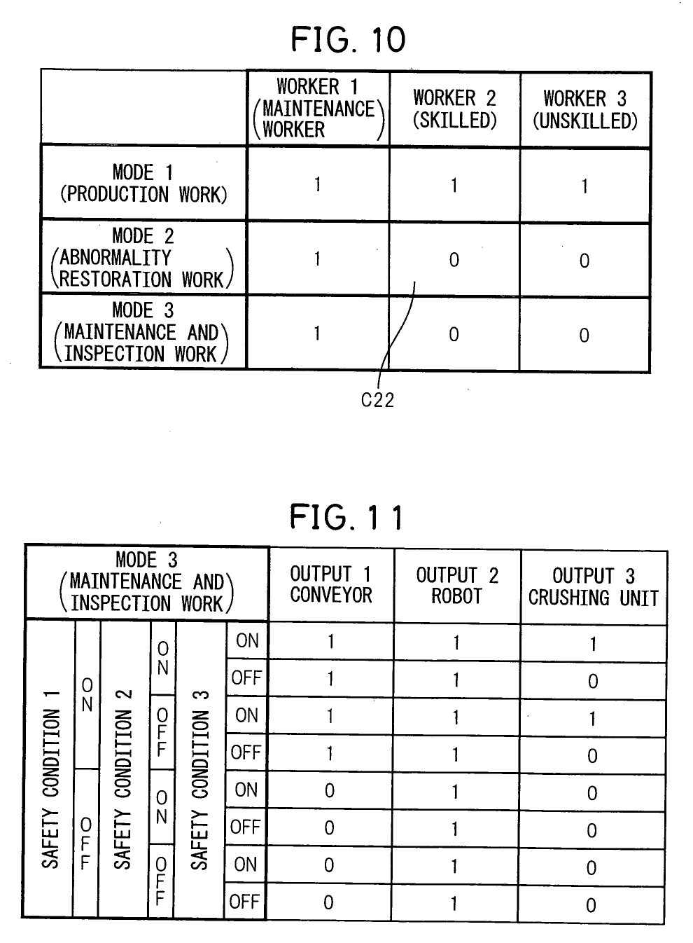

FIG. 10 shows a modification of a work content-worker type relationship table. If changing the table so that the abnormality restoration work of the mode 2 includes work which can be performed only by a maintenance worker (worker 1), a worker 2 can no longer perform the work of the mode 2. In this case, it is possible to easily and uniformly change the control sequence by just changing the value of the cell 22 at the intersection of the row heading “mode 2” and the column heading “worker 2” of the work content-worker type relationship table T0.

After the change, even if inputting as the worker type the worker 2 and selecting as the work content the mode 2, the work content-worker type relationship table T0 outputs “0”, so the processing is ended without referring to the work content-equipment operation relationship tables T11 to T13.

FIG. 11 shows a modification of a work content-equipment operation relationship table. FIG. 11 is an example of modification of the work content-equipment operation relationship table T3 of the mode 3. When changing the table so that in the maintenance and inspection work of the mode 3, when the maintenance and inspection door is open and a maintenance worker can enter the processing chamber, that is, when the safety condition 2 is OFF, the robot 21 (equipment 2) can be operated, it is sufficient to change all of the cells of the column heading “output 2” of the work content-equipment operation relationship table T3 to “1”.

As explained above, according to the present invention, both when the work itself or the work environment changes, the control sequence can be easily and uniformly changed to the optimum sequence. For example, even when establishing the Factory Equipment overseas where the laws and customs are different, it is possible to construct the optimum, safety Factory Equipment for that site.

Further, when constructing a transfer line comprised of a plurality of production facilities as well, these tables may be combined so to as secure safety in the transfer line as a whole.

Furthermore, when suspending safety measure means or when changing to other means as well, these can be easily handled. For example, when the safety measure means of the light curtain is no longer necessary, for example the cells of the safety condition 3 may be left blank. Further, even if changing the safety condition 3 from a light curtain to a third door, it is possible to make the safety condition 3 the third door and set the “0” and “1” so as to define the operations of the outputs 1 to 3.

Further, in the present embodiment, the work content, worker type, safety conditions, and equipment (output) were all made three types and a work content-worker type relationship table and work content-equipment operation relationship tables of corresponding sizes were used, but it is also possible to use tables of even greater sizes to enable addition of the items of the work content, worker type, safety conditions, and equipment (output).

For example, the work content-worker type relationship table may be made a 10-row 10-column table so as to enable addition or further division of the work content and worker type to be handled. According to this, for example, it is possible to easily handle the case of classifying maintenance workers into class 1 maintenance workers and class 2 maintenance workers and assigning them different work. For the work content as well, it is possible to handle establishment of new work modes etc. Other changes can also be flexibly handled.

In the work content-equipment operation relationship tables as well, it is possible to prepare tables of a size with some extra margin in advance so as to enable any added safety measures to be easily incorporated into the work content-equipment operation relationship table. Further, addition of output, that is, equipment, can also be easily handled.

Further, the work content-worker type relationship table and work content-equipment operation relationship tables are not limited to two-dimensional tables. These tables are stored in the memory, so can also be stored as three-dimensional or higher dimensional tables.

Furthermore, the work content-worker type relationship table and work content-equipment operation relationship tables may be changed, for example, by displaying the tables of FIGS. 4 to 7 on a display device such as a display unit 28 provided in the input apparatus 22 and inputting operable and inoperable to change them. Further, it is possible to display Factory Equipment operation element control diagrams shown in FIGS. 8, 9 and input “1” and “0” to change them. Alternatively, it is possible to change the tables to designate the conditions to be changed. Alternatively, it is possible to respond to questions displayed on the display device so as to change the values of the cells of these tables.

While the invention has been described with reference to specific embodiments chosen for purpose of illustration, it should be apparent that numerous modifications could be made thereto by those skilled in the art without departing from the basic concept and scope of the invention.

1. A Factory Equipment having at least one piece of equipment and at least one safety measure, comprising:
a worker type input unit inputting a type of worker,
a work content input unit for inputting a work content,
a safety condition detection unit detecting a state of said safety measure,
a memory storing a work content-worker type relationship table defining whether said work content can be performed for each said type of worker and a work content-equipment operation relationship table prepared for each work content and defining whether said equipment can be operated in accordance with said safety conditions,
a work content judgment unit referring to said work content-worker type relationship table based on the input worker type from said worker type input unit and the input work content from said work content input unit so as to judge if the worker of the input worker type can perform the input work content, and
an equipment operation judgment unit referring to said work content-equipment operation relationship table based on said work content and the safety conditions input from said safety condition detection unit when it is judged that said input work content can be performed so as to judge if said equipment can be operated.

2. A Factory Equipment as set forth in claim 1, further comprising a relationship information changing means for changing at least one of information of said work content-worker type relationship table showing if work is possible and information of said work content-equipment operation relationship table showing if operation is possible.

3. A Factory Equipment as set forth in claim 1, said work content-worker type relationship table displays types of workers and work contents as row and column headings and stores information on whether the work is possible in the cells at the intersections of the rows and columns.

4. A Factory Equipment as set forth in claim 1, wherein said work content-equipment operation relationship tables display combinations of said safety conditions and said equipment as row and column headings and stores information on whether the equipment can be operated in the cells at the intersections of the rows and columns.

5. A control method for a Factory Equipment having at least one piece of equipment and at least one safety measure, comprising:
inputting a worker type,
inputting a work content,
detecting a state of said safety measure,
referring to a work content-worker type relationship table showing the work content which can be performed for each type of worker based on said input worker type and said input work content so as to judge if a worker of the input worker type can perform the input work content,
referring to a work content-equipment operation relationship table prepared for each work content and defining whether said equipment can be operated in accordance with predetermined safety conditions based on said work content and said detected safety conditions when it is judged that said input work content can be performed so as to judge if said equipment can be operated, and
controlling the operation of said equipment based on the judgment of said equipment operation.

6. A control method for a Factory Equipment as set forth in claim 5, wherein said work content-worker type relationship table displays types of workers and work contents as headings of rows or columns and stores information on whether work is possible in cells at the intersections of the rows and columns.

7. A control method for a Factory Equipment as set forth in claim 5, wherein said work content-equipment operation relationship tables display combinations of said safety conditions and said equipment as headings of rows or columns and stores information on whether the equipment can be operated in cells at the intersections of the rows and columns.

8. A Factory Equipment control apparatus controlling a Factory Equipment having at least one piece of equipment and at least one safety measure, comprising:
a memory storing a work content-worker type relationship table defining whether said work content can be performed for each said type of worker and a work content-equipment operation relationship table prepared for each work content and defining whether said equipment can be operated in accordance with said safety conditions,
a work content judgment unit referring to said work content-worker type relationship table based on the input worker type and the input work content to judge if the worker of the input worker type can perform the input work content, and
an equipment operation judgment unit referring to said work content-equipment operation relationship tables based on said work content and safety conditions showing the state of said safety measures when it is judged that said input work content can be performed so as to judge if said equipment can be operated.

9. A Factory Equipment control apparatus as set forth in claim 8, wherein said work content-worker type relationship table displays types of workers and work contents as headings of rows or columns and stores information on whether work is possible in cells of the intersections of the rows and columns.

10. A Factory Equipment control apparatus as set forth in claim 8, wherein said work content-equipment operation relationshiop tables display combinations of said safety conditions and said equipment as headings of rows or columns and stores information on whether the equipment can be operated in cells at the intersections of the rows and columns.
